(19) United States
(12) Patent Application Publication
(10) Pub. No.: US 2006/0265814 A1
(43) Pub. Date: Nov. 30, 2006

(54) Antimicrobial finishing of textile fabrics

(75) Inventor: Wolfgang Ritter, Offstein (DE)

Correspondence Address: ROTHWELL, FIGG, ERNST & MANBECK, P.C., 1425 K STREET, N.W., SUITE 800, WASHINGTON, DC, 20005, US

(73) Assignee: Fritz Blanke GmbH & Co. KG, Bad Salzuflen (DE)

(21) Appl. No.: 11/416,383

(22) Filed: May 3, 2006

(30) Foreign Application Priority Data
May 4, 2005 (DE) 10 2005 020 889.4

(51) Int. Cl. C11D 3/00

(52) U.S. Cl. 8/115.51

(57) ABSTRACT

A process for antimicrobial finishing of textile fabrics, especially of wovens, includes the steps of: a) treating a textile fabric with a first dilute aqueous liquor including at least one water-soluble polymeric dispersant and/or a polymeric thickener and at least one particulate silvery constituent selected from i) sparingly water-soluble salts of silver, ii) a silver sol and iii) a pulverulent silvery material, and b) treating the textile fabric with a second aqueous liquor b) including an aqueous composition of a binder.

### FIELD OF THE INVENTION

The present invention relates to a process for antimicrobial finishing of textile fabrics, especially wovens, by treatment with dilute aqueous liquors comprising particulate silvery constituents.

### DESCRIPTION OF THE BACKGROUND

The antimicrobial properties of silver and silver(I) salts are well known and still find medical use today, for example in Credéprophylaxis (see for example A. B. G. Landsdown, Journal of Woundcare, 11 (2002), p. 125 to 130 and references cited therein).

There have been various reports about the use of silver and silver compounds for antimicrobial finishing of wovens. For instance, U.S. Pat. No. 2,689,809 and U.S. Pat. No. 2,791,518 describe a process for antimicrobial finishing of wovens wherein the woven is impregnated with an aqueous solution of a silver salt and the silver salt is subsequently precipitated in the textile. It is disadvantageous that it takes two stages to apply the silver compounds. Moreover, the durability of the antimicrobial finish, especially to laundering, is unsatisfactory.

To improve the properties and durability of antimicrobial finishes based on silver, WO 00/49219 proposes impregnating the woven first with solubilized chitosan and then with a solution of a silver salt, then to treat the woven with a reducing agent and subsequently to crosslink the chitosan. This process is comparatively costly and inconvenient because of the multiplicity of steps.

WO 01/49115 describes a process for antimicrobial finishing of wovens wherein the woven is initially impregnated with an aqueous solution of a silver salt and then treated with an oxidizing agent in the presence of a base, for example with a persulfate in the presence of alkali metal hydroxide, to precipitate silver(I,III) oxide. However, the use of oxidizing agent can lead to damage to the woven.

U.S. Pat. No. 6,821,936 describes a process for antimicrobial finishing of wovens and yarns wherein silver-containing substances such as ion exchanger resins, zeolites or silver-releasing glasses are deposited on a woven fabric or yarn and fixed with a binder. First, the silver substances used are comparatively costly. Secondly, the stiff hand of the wovens obtained in this way is disadvantageous. Thirdly, comparatively high temperatures are needed to deposit the silver substance on the woven. U.S. Pat. No. 6,584,668 discloses similar art.

### SUMMARY OF THE INVENTION

It is an object of the present invention to provide a simple process for antimicrobial finishing of textile fabrics. The antimicrobial finish should be notable for good laundering durability. In addition, the tactile properties of the textile should not be greatly affected, if at all. We have found that these and further objects are achieved by the process described hereinbelow.

The present invention accordingly provides a process for antimicrobial finishing of textile fabrics, especially of wovens, comprising the steps of:
a) treating said textile fabric with a first dilute aqueous liquor comprising at least one water-soluble polymeric dispersant and/or a polymeric thickener and at least one particulate silvery constituent selected from
   i. sparingly water-soluble salts of silver,
   ii. a silver sol and
   iii. a pulverulent silvery material, and
b) treating said textile fabric with a second aqueous liquor b) comprising an aqueous binder composition.

### DETAILED DESCRIPTION OF THE INVENTION

The process of the present invention is simple to carry out and provides textile fabrics having a high antimicrobial effect, for example against staphylococci such as Staphylococcus aureus, against pseudomonas such as Pseudomonas aeuginosa, against klebsiella such as Klebsiella pneumoniae, but also against yeast fungi such as Candida albicans. In addition, the antimicrobial finish obtainable according to the present invention is notable for good laundering durability. The textile fabrics obtainable by the process of the present invention are therefore likewise part of the subject matter of the present invention.

In accordance with the present invention, the textile fabric to be finished is treated in a first step with a first dilute aqueous liquor comprising at least one particulate silvery constituent and at least one water-soluble polymeric dispersant and/or a polymeric thickener.

Useful water-soluble dispersants include in principle all water-soluble polymers customarily used in aqueous systems to stabilize particulate substances. This includes polymers polymerized from ethylenically unsaturated mono- and/or dicarboxylic acids, examples being polyacrylic acids, copolymers of acrylic acid with methacrylic acid and/or maleic acid, especially their sodium salts or ammonium salts, homo- and copolymers of amido-bearing monoethylenically unsaturated monomers such as acrylamide, methacrylamide or N-vinylpyrrolidone, examples being polyacrylamide and polyvinylpyrrolidone, also polyvinyl alcohol, polyethers such as polyethylene oxide and polyethylene oxide-polypropylene oxide copolymers, polystyrene-block-polyethylene oxide, and AB comb polymers, for example polymethyacrylic-comb-polyethylene oxide and native water-soluble polymers, their degradation products and modified native polymers, examples being polysaccharides including starch, starch degradation products, starch derivatives, celluloses and modified cellulose such as carboxymethylcellulose, hydroxyethyl- and hydroxypropylcellulose, xanthane and alginates, water-soluble proteins such as caseins, and gelatin including type A gelatin and type B gelatin. Particular preference is given to proteins, in particular gelatins. Likewise suitable water-soluble polymers include homo- and copolymers of amido-bearing monoethylenically unsaturated monomers with particular preference given to polyvinylpyrrolidones and vinylpyrrolidone-containing copolymers. The concentration of water-soluble polymer in the liquor is typically in the range from 0.5 to 50 g/l and especially in the range from 1 to 10 g/l.

Useful polymeric thickeners include not only the aforementioned dispersants such as gum arabic, gelatin, caseins, starch, alginates, polyethers, cellulose derivatives such as methyl-, carboxymethylcellulose, hydroxyethyl- and hydroxypropylcellulose, polyacrylic acid salts, such as the sodium salt or the ammonium salt of polyacrylic acid, but also hydrophobic modified polyurethanes (associative thickeners) and aqueous copolymeric dispersions of ethylenically unsaturated mono- and dicarboxylic acids such as acrylic acid, methacrylic acid or maleic acid with hydrophobic comonomers, examples being C1-C10-alkyl acrylates or methacrylates, C2-C14-olefins or styrene, the fraction of polymerized monoethylenically unsaturated carboxylic acids in the polymeric dispersions being typically at least 5% by weight, based on the monomers constituting the copolymer, and typically in the range from 5% to 50% by weight. The concentration of polymeric thickener in the liquor is typically in the range from 0.5 to 50 g/l and especially in the range from 1 to 20 g/l. The total concentration of polymeric dispersant and polymeric thickener in the liquor is typically in the range from 0.5 to 50 g/l and especially in the range from 1 to 20 g/l.

The concentration of silver or silvery constituent in the aqueous liquor is typically in the range from 10 to 1000 mg/l, preferably in the range from 20 to 800 mg/l and specifically in the range from 50 to 500 mg/l, all reckoned as silver. In the case of silver particles having sizes in the micrometer range, the aqueous liquors may also comprise higher concentrations of silver, for example up to 5000 mg/l.

In a first embodiment i, the silvery constituent is a sparingly water-soluble salt of silver such as silver phosphate or especially a silver halide such as silver chloride, silver bromide, silver iodide or a mixture thereof, specifically a mixture of silver chloride with silver bromide. It will be particularly useful to use a sparingly soluble salt of silver that was precipitated from an aqueous solution of a water-soluble salt of silver such as silver nitrate comprising at least one water-soluble polymeric dispersant. The precipitation is effected by addition of a precipitant, converting the water-soluble salt of silver to a water-insoluble salt of silver. Useful precipitants include accordingly not only alkali and alkaline earth metal hydroxides, alkali metal phosphates, hydrogenphosphates and ammonium hydrogenphosphates, but also alkali metal halides, alkaline earth metal halides and ammonium halides, the halides, especially the chlorides and bromides, being particularly preferred. Advantageously, precipitation is effected by addition of an aqueous silver salt solution, for example of a silver nitrate solution, to an aqueous solution of the precipitant comprising the water-soluble polymeric dispersant. The temperatures at which the precipitation is carried out are typically in the range from 10 to 100° C. and especially in the range from 20 to 80° C. The concentration of dispersant is typically in the range from 1 to 100 g/l. Advantageously, the concentrations for the precipitation are chosen so as to initially obtain a dispersion of the water-insoluble salt of silver having a content in the range from 0.1% to 10% by weight, reckoned as silver, before this suspension/dispersion is diluted to the desired liquor concentration. The liquors thus produced comprise very small particulate silver salt constituents having particle sizes of generally below 500 nm, especially in the range from 1 to 300 nm.

In a second embodiment ii, the first dilute aqueous liquor comprises the particulate silvery constituent in the form of a silver sol, i.e., in the form of elemental silver having very small particle sizes, which are typically below 500 nm and especially in the range from 1 to 300 nm or below. The silver sol is prepared in a conventional manner by adding at least one reducing agent to an aqueous solution of a silver salt, for example to an aqueous silver nitratesolution. Useful reducing agents include known organic reducing agents such as, for example, formaldehyde, ascorbic acid, sugar aldehydes, etc., but also inorganic reducing agents such as non-noble metals, for example zinc, but also compounds such as sulfurous acid, phosphorous acid and salts thereof such as, for example, sodium boranate. The amount of reducing agent is typically in the range from 0.5 to 10 mol per mole of silver salt. The sol is typically prepared at temperatures in the range from 5 to 80° C. and the preparation may be promoted by means of sunlight or by means of UV irradiation, if appropriate. Advantageously, the sol is prepared in the presence of the water-soluble polymeric dispersant in the above-stated amount. The silver sol thus obtained can subsequently be diluted to the desired liquor concentration.

In a third embodiment of this invention, the first aqueous liquor comprises a pulverulent silvery constituent as particulate silvery constituent. By pulverulent silvery constituent is meant silver or silvery materials having particle sizes of typically below 100 μm, for example in the range from 0.5 to 100 μm, especially in the range from 1 to 50 μm and specifically in the range from 2 to 20 μm (the reported particle sizes are based on the mass median, i.e., the d50 value). More particularly, the pulverulent silvery constituent has a particle size distribution where the d10 value is in the range from 0.5 to 20 μm, specifically 1 to 10 μm, the d50 value is in the range from 1 to 50 μm, specifically 2 to 20 μm, and the d90 value is in the range from 5 to 100 μm, specifically 10 to 50 μm. Examples of pulverulent silvery constituents are silver flakes, silver needles or advantageously silver-coated ceramic or glass powder. The weight fraction of silver in the coated ceramic or glass powder is generally at least 3% by weight and preferably at least 5% by weight and will generally not exceed a value of 70% by weight and especially 50% by weight, all based on the total weight of the powder. More particularly, the weight fraction of silver in the coated ceramic or glass powder is in the range from 10% to 40% by weight and more preferably in the range from 15% to 35% by weight. Such powders are known and commercially available, for example as Conduct-O-Fil® Silver Coated Hollow Glass Spheres (borosilicate glass, 20 to 33±2% silver), for example the grades SH230S33, SH400S33, Conduct-O-Fil® Silver Coated Glass Spheres (4 to 20±2% silver), for example the grades S-2429-S, S-3000-S, S-3000-S2E, S-3000-S2M, S-3000-S3E, S-3000-S3M, S-3000-S3N, S-3000-S4M, S-4000-S3, S-5000-S2, S-5000-S3, and Conduct-O-Fil® Silver Coated Hollow Ceramic Additive (16 to 30±2% silver), for example the grades AG-SL 150-16-TRD and AG-SL 150-30-TRD, from Potters Industries Inc. Valley Forge, Pa. USA or from Potters-Ballotini, Kirchheim-Bolanden/Germany, and also the Sil Shield products from Nanotechnologie bv Hollandiastraat 5 6006 TT Weert, Netherlands, for example Sil Shield Ag/hs 10/33. To stabilize the silver particles, such liquors typically comprise at least one of the abovementioned dispersing and/or thickening agents. Preferred thickening agents are the aqueous copolymeric dispersions—known as thickeners—of ethylenically unsaturated mono- and dicarboxylic acids with hydrophobic comonomers and also so-called associative thickeners based on polyurethane. The amount of thickener polymer is typically so chosen that the viscosity of the liquor is in the range from 1 to 5000 mPa.s and especially in the range from 10 to 1000 mPa.s (at 25° C.). The concentration of polymeric thickener is typically in the range from 0.5 to 50 g/l and especially in the range from 1 to 20 g/l.

In a fourth embodiment of this invention, the first aqueous liquor comprises as particulate silvery constituent a pulverulent silvery constituent as described above for the third embodiment and a finely divided silvery constituent having an average particle size below 500 nm, especially in the range from 1 to 300 nm, for example a sparingly soluble salt of silver and/or a silver sol, as previously described for the first and second embodiments. The weight ratio of pulverulent silvery constituent to finely divided silvery constituent is then preferably in the range from 1000:1 to 1:100 and especially in the range from 100:1 to 1:10.

The treating of the textile fabrics with the first dilute aqueous liquor is effected in a conventional manner by drenching the woven fabric with the dilute aqueous liquor, for example by means of a padder or in a washing machine or by spraying. The treatment is advantageously carried out such that the wet pickup is at least 50%, especially at least 70%, for example 70% to 95%. Correspondingly, the textile fabric thus treated has a silver content of typically 10 to 1000 μg/g, advantageously 20 to 800 μg/g and especially 50 to 500 μg/g silver after the treatment. In principle, however, larger amounts of silver, for example up to 10000 μg/g and especially up to 5000 μg/g can also be applied, especially in the case of the third and fourth embodiments.

The textile fabric treated in step a) can be dried before treating it with the second aqueous liquor b). Frequently, however, no drying step is utilized. It is similarly possible to combine the treating of the textile fabric in step a) with the treating of the textile fabric in step b) to one operation, i.e., the first dilute aqueous liquor a), as well as the at least one particulate silvery constituent, further already comprises the binder.

In accordance with the present invention, the textile fabric is also treated with a second aqueous liquor b) comprising an aqueous composition of a polymeric binder which may be crosslinkable. The binders are preferably water-insoluble polymers or prepolymers which form a water-insoluble polymeric film as the treated fabric dries. More particularly, the binder comprises polymers or prepolymers having a multiplicity of reactive groups which, as the treated fabric dries, if appropriate at elevated temperature, react with each other, or with a low molecular weight crosslinker, by bond formation and thus form a particularly firm, water-insoluble polymeric film.

Aqueous polymeric binder compositions useful for the process of the present invention are those in particular which are used as hand-modifying finishes for textiles (see for example J. Hemmrich, Int. Text. Bull. 39, 1993, No. 2, p. 53-56; “Wässrige Polyurethan-Beschichtungssysteme” Chemiefasern/Textilind. 39 91 (1989) T149, T150; W. Schröer, Textilveredelung 22, 1987, p. 459-467). Aqueous dispersions of this type are commercially available, for example as Alberdingk□ from Alberdingk, D-Krefeld, Impranil® from Bayer AG, Permutex® from Stahl, Waalwijk, The Netherlands, Quecodur and Rhenapret from Thor GmbH, Landwehrstr.1, D-67346 Speyer, Meikanates from Mitsubishi International GmbH, Kennedydamm 19 in D-40476 Düsseldorf, or can be prepared by known processes, as described for example in “Herstellverfahren für Polyurethane” in Houben-Weyl, “Methoden der organischen Chemie”, volume E 20/Makromolekulare Stoffe, p. 1587, D. Dietrich et al., Angew. Chem. 82 (1970), p. 53 ff., Angew. Makrom. Chem. 76, 1972, 85 ff. and Angew. Makrom. Chem. 98, 1981, 133-165, Progress in Organic Coatings, 9, 1981, p. 281-240, or Römpp Chemielexikon, 9th edition, volume 5, p. 3575.

It is preferable for the binder polymers to have a glass transition temperature TG in the range from −40 to 100° C., preferably 30 to +60° C. and especially −20 to +40° C. When the polymeric binder comprises a plurality of polymeric components, at least the main constituent should have a glass transition temperature in this range. More particularly, the glass transition temperature of the main constituent is in the range from −20° C. to +60° C. and more preferably in the range from −10° C. to +40° C. The surface may be tacky when the glass transition temperature is too low. The reported glass transition temperatures are based on the midpoint temperature determined by DSC in accordance with ASTM-D 3418-82. In the case of crosslinkable binders, the glass transition temperature relates to the uncrosslinked state.

The polymeric binders are customarily based on the following classes of polymer:
(1) polyurethane resins
(2) acrylate resins (straight acrylates: copolymers of alkyl acrylates and alkyl methacrylates);
(3) styrene acrylates (copolymers of styrene and alkyl acrylates);
(4) styrene-butadiene copolymers;
(5) polyvinyl esters, especially polyvinyl acetates and copolymers of vinyl acetate with vinyl propionate;
(6) vinyl ester-olefin copolymers, for example vinyl acetate-ethylene copolymers;
(7) vinyl ester-acrylate copolymers, for example vinyl acetate-alkyl acrylate copolymers, and also vinyl acetate-alkyl acrylate-ethylene terpolymers;
(8) silicone rubbers (polysiloxanes)
   and binders of polymer class (1), i.e., polyurethanes, are particularly preferred.

The binders are preferably crosslinkable, i.e., the polymers have functional groups (crosslinkable groups) which react with each other or with a low molecular weight crosslinker by bond formation in the course of drying with or without heating.

Examples of crosslinkable functional groups comprise aliphatically attached OH groups, NH—CH2-OH groups, carboxylate groups, anhydride groups, isocyanate groups, blocked isocyanate groups and amino groups. The fraction of reactive functional groups is generally in the range from 0.1 to 3 mol/kg of polymer. The crosslinking can be effected within the polymer through reaction of complementarily reactive functional groups. The crosslinking of the polymer is preferably effected by adding a crosslinker having reactive groups which are complementary in terms of their reactivity to the functional groups of the crosslinker. Suitable pairs of functional groups having a complementary reactivity will be known to one skilled in the art. Examples of such pairs are OH/COOH, OH/NCO, NH2/COOH, NH2/NCO and also M2+/COOH, where M2+ represents a divalent metal ion such as Zn2+, Ca2+ or Mg2+. Preferably, the binder polymer comprises blocked isocyanate groups as reactive groups.

Examples of useful low molecular weight crosslinkers are the di- or polyols specified hereinbelow for the polyurethanes; primary or secondary diamines, preferably primary diamines, for example alkylenediamines such as hexamethylenediamine, diethylenetriamine, triethylenetetramine, tetraethylenepentamine, N,N-bis[(aminopropyl)amino]ethane, 3,6-dioxaoctanediamine, 3,7-dioxanonanediamine, 3,6,9-trioxaundecanediamine or Jeffamines, (4,4′-diaminodicyclohexyl)methane, (4,4′-diamino-3,3-dimethyldicyclohexyl)methane; amino alcohols such as ethanolamine, hydroxypropylamine; ethoxylated di- and oligoamines; dihydrazides of aliphatic or aromatic dicarboxylic acids such as adipic dihydrazide; dialdehydes such as glyoxal; partially or fully O-methylated melamines, and also compounds or oligomers having on average two or more, preferably three or more, isocyanate groups or reversibly blocked isocyanate groups. In this case, the quantitative ratio of crosslinker to polymeric binder is determined such that the molar ratio of the reactive groups in the polymeric binder (total amount of reactive groups in the polymers) to the reactive groups in the crosslinker is generally in the range from 1:10 to 10:1 and preferably in the range from 3:1 to 1:3. Customarily, the weight ratio of polymeric binder (reckoned as solid) to crosslinker is in the range from 100:1 to 1:1 and especially in the range from 50:1 to 5:1.

In accordance with the present invention, preferred binders comprise at least 50% by weight of polyurethanes, based on the total weight of binder polymers in the composition. The polyurethane fraction provides a soft hand and a high laundering durability.

Polyurethanes, as will be known, are addition products of at least one polyisocyanate component and at least one polyol component. The polyisocyanate component generally comprises at least one diisocyanate. The isocyanate component may additionally also comprise isocyanates of higher functionality, for example triisocyanates or oligomeric isocyanates having on average more than two and preferably three or more isocyanate groups. The polyol component generally comprises at least one diol. The polyol component may further comprise higher-functionality polyols or oligomeric polyols having on average more than two OH groups, preferably three, four or more OH groups.

Useful diisocyanates are aromatic diisocyanates such as 2,4-and 2,6-tolylene diisocyanate (TDI) and isomeric mixtures thereof, tetramethylxylylene diisocyanate (TMXDI), xylylene diisocyanate (XDI), diphenylmethane 4,4′-diisocyanate (MDI) and also aliphatic and cycloaliphatic diisocyanates, such as dicylohexylmethane 4,4′-diisocyanate (H12MDI), tetramethylene diisocyanate, hexamethylene diisocyanate (HMDI), isophorone diisocyanate (IPDI), trimethylhexamethylene diisocyanate and also mixtures thereof. Preferred diisocyanates include hexamethylene diisocyanate (HMDI) and isophorone diisocyanate. Examples of isocyanates of higher functionality are triisocyanates such as triphenylmethane 4,4 ′,4″-triisocyanate, the partial condensation products of the abovementioned diisocyanates such as cyanurates and biurets of the aforementioned diisocyanates and also oligomers obtainable by controlled reaction of diisocyanates or of semiblocked diisocyanates with polyols having on average more than two and preferably at least three OH groups per molecule.

Preferred polyisocyanates are aliphatic or cycloaliphatic in nature. Especially diisocyanates of the general formula
OCN—(CH₂)ₙ—NCO
where n is 2 to 8 and especially 4 to 6 are preferred. The fraction of the polyisocyanate component which is attributable to constituents forming the polyurethane is generally in the range from 5% to 60% by weight and especially in the range from 10% to 40% by weight.

The polyol component may in principle be a low molecular weight alcohol having two or more, for example three or four, OH groups or an oligomeric polyol having on average at least two, preferably two to four and especially two or three OH groups disposed at their termini in particular.

Useful low molecular weight alcohols are particularly glycols having preferably 2 to 25 carbon atoms. This includes 1,2-ethanediol, 1,2-propanediol, 1,3-propanediol, 1,4-butanediol, 1,5-pentanediol, 1,6-hexanediol, 1,10-decanediol, diethylene glycol, triethylene glycol, dipropylene glycol, tripropylene glycol, 2,2,4-trimethyl-1,5-pentanediol, 2,2-dimethyl-1,3-propanediol, 1,4-dimethylolcyclohexane, 1,6-dimethylolcyclohexane, 2,2-bis(4-hydroxyphenyl)propane (bisphenol A), 2,2-bis(4-hydroxyphenyl)butane (bisphenol B) or 1,1-bis(4-hydroxyphenyl)-3,3,5-trimethylcyclohexane (bisphenol C).

Further possible constituents for the polyol component are trihydric (triols) and more highly hydric, low molecular weight alcohols. They generally have 3 to 25 and preferably 3 to 18 carbon atoms. This includes glycerol, trimethylolethane, trimethylolpropane, erythritol, pentaerythritol, sorbitol and alkoxylates thereof.

Examples of oligomeric polyols are polyesterpolyols, polycarbonatepolyols and polyetherpolyols. The number average molecular weight of this component is preferably in the range from 500 to 20000 daltons and preferably in the range from 1000 to 10000 daltons. The oligomeric component is preferably constructed of aliphatic building blocks.

The proportion of oligomeric polyols attributable to the polyurethane-forming components is generally in the range from 10% to 95% by weight, preferably in the range from 20% to 95% by weight and especially in the range from 25% to 85% by weight based on the total weight of the polyurethane-forming components. The fraction of low molecular weight alcohols is generally not more than 60% by weight, for example in the range from 1% to 60% by weight, and frequently up to 30% by weight or up to 20% by weight.

Since it is in accordance with the present invention that the polyurethanes be used in the form of an aqueous dispersion, they generally have polar functional groups, especially ionogenic and/or ionic groups, for example anionic or anionogenic groups such as carboxylic acid groups, sulfonic acid groups, phosphonic acid groups, phosphoric acid groups, which can also be present in their salt form, for example as alkali metal and ammonium salts; cationic or cationogenic groups such as amino groups, quaternary amino groups; and/or neutral water-soluble groups such as polyether groups, preferably polyethylene oxide groups.

Preferred polyurethanes are polyurethanes having aliphatic polyether chains (preferably linear or singly branched), especially poly-C2-C4-alkylene oxide chains. These are naturally obtainable by using aliphatic polyetherpolyols to prepare the polyurethanes. The fraction of polyether urethanes which is attributable to polyether chains is preferably in the range from 5% to 80% by weight and especially 10% to 50% by weight of the total mass of the polyurethane. Preferred polyurethanes are further aliphatic polyester urethanes, i.e., polyurethanes having aliphatic polyester chains (preferably linear or singly branched) and obtainable by using the abovementioned aliphatic polyesterpolyols to prepare the polyurethanes. The fraction of polyester chains is preferably in the range from 5% to 80% by weight and especially in the range from 10% to 70% by weight of the total mass of the polyurethane. Preferred polyurethanes are further aliphatic polycarbonate urethanes, i.e., polyurethanes having aliphatic polycarbonate chains (preferably linear or singly branched) and obtainable by using the abovementioned aliphatic polycarbonatepolyols to prepare the polyurethanes. The fraction of polycarbonate chains is preferably in the range from 5% to 80% by weight and especially in the range from 10% to 70% by weight of the total mass of the polyurethane.

It is particularly preferable to perform step b) using aqueous compositions comprising reactively capped polyisocyanates as a binder. Reactively capped polyisocyanates are polymers and prepolymers having isocyanate groups which are reversibly blocked. Reversible blocking is achieved for example through reaction of polymers or prepolymers comprising isocyanate groups with carbon acids, preferably with oximes of aliphatic ketones such as butanone oxime or through the reaction with sodium sulfite or sodium hydrogensulfite.

In another embodiment, the binder composition comprises an aqueous composition of low molecular weight compounds having at least 2 N-methylol (hydroxymethyl) groups in the molecule, or comprises their reaction products with C1-C6-alkanols such as methanol, ethanol, n-propanol, diethylene glycol and the like. Examples of compounds having at least 2 N-methylol groups are urea derivatives such as N,N-bis(hydroxymethyl)imidazolin-2-one, N,N-bis(hydroxymethyl)-4,5-dihydroxyimidazolin-2-one, N,N-bis(hydroxymethyl)imidazolin-2-one, N,N-bis(hydroxymethyl)propyleneurea, tetra(hydroxymethyl)acetylenediurea and also low molecular weight melamine-formaldehyde resins, for example tris(hydroxymethyl)melamine. Products of this kind are commercially available as Fixapret® from BASF Aktiengesellschaft and Quecodur® from Thor GmbH, Landwehrstr. 1, D-67346 Speyer.

Turning now to the second liquor used in the process of the present invention, its binder content is typically in the range from 10 to 400 g/l, especially in the range from 10 to 200 g/l and specifically in the range from 10 to 50 g/l.

As well as the binder constituents, the second aqueous liquor may comprise customary auxiliaries as used in conventional hand-modifying finishing compositions for textiles and leather. The identity and amount of these auxiliaries depends in a well-known manner on the textile and on the method of impregnation. Auxiliaries include UV stabilizers, dispersing assistants, surface-active substances, thickeners, defoamers or foam-forming agents, foam stabilizers, agents for setting the pH, antioxidants, catalysts for postcrosslinking, customary hydrophobicizing agents and also preservatives, although these auxiliary classes are not always strictly distinguishable, for example in the case of surface-active substances and foam formers/foam stabilizers. In general, the total amount of customary auxiliaries will not exceed a value of 20% by weight, based on the total weight of binder present in the liquor, or 20 g/l, based on the second liquor.

Agents for setting the pH are the customarily used inorganic or organic bases, for example ammonia, alkali metal bases such as potassium hydroxide, sodium hydroxide, sodium bicarbonate, sodium carbonate, potassium carbonate, potassium bicarbonate, alkaline earth metal bases such as calcium hydroxide, calcium oxide, magnesium hydroxide or magnesium carbonate, alkylamines, such as ethylamine, diethylamine, trimethylamine, triethylamine, triisopropylamine and mono-, di- and trialkanolamines such as ethanolamine, diethanolamine, aminomethylpropanol, aminomethylpropanediol and trishydroxymethylaminomethane and also mixtures thereof.

Useful surface-active substances are the emulsifiers, polymeric surfactants and protective colloids customarily used for producing aqueous polymeric dispersions. The emulsifiers may be amphoteric, neutral, anionic or cationic in nature. One skilled in the art will know useful emulsifiers from the prior art, for example from R. Heusch, “Emulsiones” in Ullmann's Encyclopedia of Industrial Chemistry, 5th edition on CD-Rom, chapter 7. Examples of nonionic emulsifiers are alkoxylated fats and oils, for example maize (corn) oil ethoxylates, castor oil ethoxylates, tallow fat ethoxylates, glyceryl esters, for example glyceryl monostearate; fatty alcohol alkoxylates and oxo process alcohol alkoxylates; alkylphenol alkoxylates, for example isononylphenol ethoxylates; and sugar surfactants, for example sorbitan fatty acid esters (sorbitan monooleate, sorbitan tristearate), polyoxyethylene sorbitan fatty acid esters. Fatty alcohol ethoxylates are used in particular. Examples of useful anionic emulsifiers are soaps, alkane sulfonates, olefin sulfonates, alkylaryl sulfonates, alkylnaphthalene sulfonates, sulfosuccinates, alkyl sulfates and alkylether sulfates, alkyl methyl ester sulfonates and also mixtures thereof, preferably in the form of the sodium salts. Examples of polymeric surfactants are the dispersants mentioned in connection with the first liquor. The fraction of surface-active substances, based on the total weight of the polymeric constituents in the coating, is generally in the range from 0% to 20% by weight and preferably in the range from 0.1% to 10% by weight, based on the total weight of binder in the liquor.

Useful defoamers for example are higher alcohols, nonionogenic acetylene compounds, aliphatic hydrocarbons having nonionogenic constituents and also oligosiloxanes.

Examples of foam formers are the salts, especially the alkali metal and ammonium salts, of alkyl sulfates and of dialkyl esters of sulfosuccinic acid. Especially fatty acid salts are examples of foam stabilizers.

Useful thickeners are the polymeric thickeners mentioned in connection with the first liquor and also inorganic thickening agents such as silica, and also mixtures thereof. The amount of thickening agent naturally depends on the desired rheology for the second liquor and therefore can vary within wide limits.

In accordance with the present invention, the first and second liquors are aqueous systems; that is, as well as the aforementioned constituents they comprise water or a mixture of water with organic solvents which are soluble or miscible with water, the water fraction in the first and second liquors typically being at least 95% by volume and especially at least 99% by volume, based on the total amount of water plus organic solvent. Useful solvents comprise ketones such as acetone and methyl ethyl ketone, water-miscible ethers such as tetrahydrofuran, dioxane, 1,2-propanediol 1-n-propyl ether, 1,2-butanediol 1-methyl ether, ethylene glycol monomethyl ether, diethylene glycol monomethyl ether, diethylene glycol dimethyl ether, mono- or polyalcohols such as methanol, ethanol, n-propanol, isopropanol, glycol, glycerol, propylene glycol or polyethylene glycol, and also mixtures thereof.

The treating of the textile fabric with the second liquor can be effected in a conventional manner, in which case the textile fabric is first contacted with the second liquor and then dried and/or cured, preferably at elevated temperature. In the process, the binder polymers form a polymeric, water-insoluble film, if appropriate by crosslinking, and the silvery material becomes fixed in the woven fabric.

The contacting with the second liquor can be performed by the methods described for the treatment with the first liquor. In general, the treatment with the second liquor is carried on to a wet pickup of at least 50% and especially in the range from 60% to 95%. A padder is typically used for the contacting. The amount of binder applied in this way typically varies in the range from 1 to 20 g/m2 and especially in the range from 1 to 10 g/m2.

The next step is to remove the aqueous medium of the second liquor; that is, to dry the moist textile fabric. Drying is generally effected under atmospheric pressure and temperatures above 50° C., preferably in the range from about 70 to 150° C. The drying process generally takes a few seconds to several minutes, for example 20 seconds to 5 minutes, but longer drying times are possible as well. Progressive drying is preferred, i.e., the drying temperature is increased in the course of the drying operation, for example from an initial value in the range from 50 to 80° C. to a final value in the range from 120 to 150° C. Particularly good qualities are obtained in this way. This will generally be followed by a curing operation to crosslink the binder. The curing operation naturally takes place above the crosslinking temperature of the polymeric binder. For crosslinking, the temperatures will generally be above 140° C. and especially above 150° C., frequently in the range from 150° C. to 200° C. and specifically in the range from 150 to 180° C. The curing time is typically in the range from 1 min to 5 min. Drying and curing can be carried out at the same time or preferably in succession.

The textile fabrics to be finished in accordance with the present invention may comprise wovens, drawn-loop knits, formed-loop knits and nonwovens. Wovens or nonwovens are contemplated in particular. The textile fabric may be ready-produced material or else roll or bale material. The textile fabrics may be constructed of natural fiber yarns, synthetic fiber yarns and/or blend yarns, in which case the wovens typically have a basis weight in the range from 10 to 500 g/m2 and preferably in the range from 20 to 250 g/m2. In principle all fiber materials customarily used for the manufacture of textiles are contemplated. They include cotton, wool, hemp fiber, sisal fibers, flax, ramie, polyacrylonitrile fibers, polyester fibers, polyamide fibers, viscose fibers, silk, acetate fibers, triacetate fibers, aramid fibers and the like and also mixtures thereof. Glass fibers and mixtures of the aforementioned fiber materials with glass fibers, for example glass fiber/Kevlar mixtures, are also useful.

The process of the present invention provides textile fabrics having a microbiocidal finish possessing high durability, especially to laundering. Tactile properties of the textiles produced in accordance with the present invention are only minimally affected, if at all.

### IMPREGNATING EXAMPLES

### Examples 1 to 22 (Woven Fabric Finished with Silver Halide) and

### Examples 1a to 22a (Woven Fabric Obtained After Reduction with Ascorbic Acid)

a) Preparation of a Silver Halide Suspension
In 400 ml of water were dissolved in succession 5 g of sodium chloride, 1.6 g of ammonium bromide and 1.4 g of citric acid. To 400 g of this solution were added 50 g of gelatin (Gelatine reinst Article No. 4582.1 from Carl Roth GmbH u. Co Schoemperlenstr. 1-5 in D-76185 Karlsruhe) and dissolved by heating to 50° C. To this solution was gradually added with stirring at 50° C. a freshly prepared solution of 10 g of silver nitrate (silver nitrate from Mallinckrodt Baker B. V. P.O. Box 1 7400 AA Deventer Holland) in 15 g of water. This gave an aqueous silver halide suspension having a silver content of 2.1% by weight, reckoned as silver nitrate (corresponds to 1.33% by weight of silver).

b) Preparation of a Silver Halide Liquor
Liquor F1: 100 g of the silver halide suspension from a) were mixed with 3450 g of water at 23° C. to obtain an aqueous liquor having a silver content of 0.0591% by weight, reckoned as silver nitrate.
Liquor F2: 10 g of the silver halide suspension from a) were mixed with 1779 g of water at 23° C. to obtain an aqueous liquor having a silver content of 0.0118% by weight, reckoned as silver nitrate.

c) Impregnation of a Textile, General Prescription:
A woven cotton fabric having a basis weight of 142 g/m² (Article 7121005 from Textilvertrieb-Beratung GmbH, Winterlingen) was padded at room temperature with one of the liquors prepared in b). The wet pickup was 85%.
The fabric was subsequently padded with an aqueous dispersion of a crosslinkable binder to a wet pickup of 85%. Subsequently the fabric was dried at 120° C. for 5 min and cured at 160° C. for 2 min.
The quantities used are reported in Table A.
The fabric treated with liquor F1 had a silver content of 500 ppm and the fabric treated with liquor F2 had a silver content of 100 ppm.
The following binders were used:
A concentrated aqueous solution of N,N-dimethylol-4,5-dihydroxyimidazolin-2-one (Quecodur® SLF from Thor GmbH, Landwehrstr. 1, D-67346 Speyer)
B aqueous dispersion of a self-crosslinkable acrylic polymer (Rhenapret® CFA from Thor GmbH Landwehrstr. 1, D-67346 Speyer)
C aqueous aliphatic polyurethane dispersion (Rhenapret® TL 897 from Thor GmbH, Landwehrstr. 1, D-67346 Speyer)
D aqueous dispersion of a capped reactive polyurethane (Meikanate® TP 10 from Mitsubishi International GmbH, Kennedydamm 19, D-40476 Düsseldorf)
E aqueous self-crosslinkable polyurethane dispersion (Impranil® DLP 10 from Bayer AG Leverkusen)

d) Reducing the Silver Halide
The fabric obtained in c) was stored for at least 3 h under UV light in an aqueous solution of ascorbic acid (5 g/l).

Determination of Durability to Laundering:

Dried samples of the fabrics obtained in c) and d) were measured for grayness using a Datacolor SF 600 Plus CT. The results are reported in Table A (illuminant ADN deg 10).

An A4 size sample of each of the fabrics obtained in d) was washed in a conventional washing machine at 60° C. using a conventional laundry detergent (Persil) at a concentration of 3 g/l before the grayness was redetermined after the drying. The results are reported in Table A.

TABLE A

| | | | | Grayness | | |
|---|---|---|---|---|---|---|
| | Ag | Binder | | before | after | after |
| Example | liquor | | (g/l) | reduction | reduction | wash |
| Control | F1 | — | — | −0.20 | −14.52 | −1.72 |
| 1 | F1 | A | 30 | −1.26 | −14.75 | −1.90 |
| 2 | F1 | A | 60 | −0.94 | −15.37 | −2.50 |
| 3 | F1 | A | 120 | −0.61 | −13.34 | −4.27 |
| 4 | F1 | B | 30 | −1.14 | −18.24 | −8.4 |
| 5 | F1 | B | 120 | −1.70 | −20.13 | −11.6 |
| 6 | F1 | C | 100 | −1.81 | −17.99 | −10.4 |
| 7 | F1 | C | 300 | −1.98 | −20.02 | −12.8 |
| 8 | F1 | D | 30 | −2.34 | −16.05 | −8.28 |
| 9 | F1 | D | 100 | −3.07 | −16.67 | −7.91 |
| 10 | F1 | E | 30 | −1.15 | −17.91 | −7.03 |
| 11 | F1 | E | 100 | −1.79 | −18.01 | −4.97 |
| Control | F2 | — | — | −0.32 | −6.84 | −0.34 |
| 12 | F2 | A | 30 | −0.59 | −3.57 | −1.57 |
| 13 | F2 | A | 60 | −1.08 | −4.79 | −2.18 |
| 14 | F2 | A | 120 | −0.73 | −4.82 | −2.55 |
| 15 | F2 | B | 30 | −0.90 | −5.32 | −3.77 |
| 16 | F2 | B | 120 | −1.75 | −7.85 | −3.25 |
| 17 | F2 | C | 100 | −1.82 | −6.47 | −3.98 |
| 18 | F2 | C | 300 | −2.32 | −9.11 | −5.87 |
| 19 | F2 | D | 30 | −1.08 | −7.24 | −5.26 |
| 20 | F2 | D | 100 | −1.47 | −7.80 | −6.29 |
| 21 | F2 | E | 30 | −1.74 | −8.37 | −5.04 |
| 22 | F2 | E | 100 | −1.73 | −9.28 | −5.95 |

The values show that silver halide or silver remains behind on the fabric after washing when the polymeric binder grades C, D and E are used in particular.

### Examples 23 to 32 (Woven Fabric Finished With Colloidal Silver)

a) Preparation of Liquor with Gelatin as Water-Soluble Dispersant:
The silver quantity reported in Table B was dissolved in 900 ml of an aqueous gelatin solution (Gelatine reinst Article No. 4582.1 from Carl Roth GmbH) having a gelatin concentration of 5.5 g/l and gradually mixed at room temperature with a solution of 1 g of ascorbic acid in 99 ml of water to obtain a silver sol which was stable for at least 20 h.

b) Preparation of Liquor with Polyvinylpyrrolidone as Water-Soluble Dispersant:
amount of silver reported in Table B was dissolved in 900 ml of an aqueous solution of polyvinylpyrrolidone having a concentration of 5.5 g/l and gradually admixed at room temperature with a solution of 1 g of ascorbic acid in 99 ml of water to obtain a silver sol which was stable for 20 h at least.

c) Impregnation of a Textile, General Prescription:
a woven cotton fabric having a basis weight of 142 g/m² (Article 7121005 from Textilvertrieb-Beratung GmbH, Winterlingen) was padded at room temperature with one of the liquors prepared in a) or b). The wet pickup was 85%.
The fabric was subsequently padded with an aqueous dispersion of a crosslinkable binder (Impranil DLP from Bayer AG, Leverkusen) to a wet pickup of 85%. Subsequently the fabric was dried at 120° C. for 5 min and cured at 160° C. for 2 min.

Dried samples of the fabrics obtained in c) were measured for grayness using a Datacolor SF 600 Plus CT. The results are reported in Table B (illuminant ADN deg 10).

TABLE B

| Example | AgNO₃ [mg] | Dispersant | Grayness |
|---|---|---|---|
| 23 | 500 | Gelatin | −11.76 |
| 24 | 250 | Gelatin | −9.13 |
| 25 | 125 | Gelatin | −6.32 |
| 26 | 62.5 | Gelatin | −2.78 |
| 27 | 31.0 | Gelatin | −3.24 |
| 28 | 500 | PVP | |
| 29 | 250 | PVP | |
| 30 | 125 | PVP | |
| 31 | 62.5 | PVP | |
| 32 | 31.0 | PVP | |

### Examples 33 to 38 (Woven Fabric Finished with Silver Spheres)

The silvery constituent used was silver-coated hollow glass spheres having the following particle size distribution: 8.1 micrometers (D10), 14.8 micrometers (D50), 25.8 micrometers (D90), a specific surface area of 4325 m2/kg and a silver fraction of 33.2% by weight (Sil Shield Ag/hs 10/33 from Nanotechnology bv, Hollandiastraat 5, 6006TT Weert).

The binder used was an aqueous polyurethane dispersion (Impranil® DLP 10 from Bayer AG, Leverkusen).

The thickener used was an aqueous dispersion of a copolymer based on methacrylic acid and ethyl acrylate, having a solids content of about 30% by weight and a viscosity in the range from 5 to 30 mPa.s at 20° C. and pH 5 (Rohagit® SD15 from Polymer Latex GmbH & Co. KG).

a) General Prescription for Preparing Liquor
To 960 g of a dilute dispersion of the binder, having a binder concentration of X g/l, were added 20 g of the aqueous dispersion of the thickener and stirred in for 5 min. Thereafter, 20 ml of aqueous ammonia (2.5% by weight) were added with stirring and then the pH was determined after a further 5 min of stirring. The pH in all cases was found to be in the range from 9.1 to 9.8. Then, Y mg of the silver-coated hollow glass spheres were added with stirring before the viscosity of the liquor was determined after Brookfield. The quantities used and the viscosity and also the viscosity of a sample diluted to twice its volume and also the sedimenting stability are reported in Table C.

b) Impregnation of a Textile, General Prescription:

A woven cotton fabric 6×A4 in size and having a basis weight of 137 g/m² (from Textil-Beratungs GmbH, Winterlingen) was padded at room temperature with one of the liquors prepared in a). Wet pickup was 85%. The fabric was subsequently dried at 120° C. for 5 min and cured at 160° C. for 2 min. Examples 33 to 38 are summarized in Table C.

TABLE C

| | Example | | | | | |
|---|---|---|---|---|---|---|
| | 33 | 34 | 35 | 36 | 37 | 38 |
| Silver | 120 | 600 | 6000 | 120 | 600 | 6000 |
| [mg] | | | | | | |
| Binder | 30 | 30 | 30 | 100 | 100 | 100 |
| [g/l] | | | | | | |
| Liquor | 9.65 | 9.39 | 9.67 | 9.12 | 9.42 | 9.13 |
| pH | | | | | | |
| Viscosity | 175 | 141 | 131 | 138 | 125 | 133 |
| (mPa · s) | | | | | | |
| Stability | >7 | >7 | 2 | 7 | 7 | 3 |
| (d) | | | | | | |

A woven cotton fabric was finished similarly to Example 35 but without silver spheres as a reference to demonstrate fixation and laundering durability. The reference sample thus finished and the fabric samples according to Examples 35 and 38 were dried at 120° C. to constant weight before a 100 g sample of each was ashed at 850° C. to determine the residue.

One fabric sample in each case was washed once at 60° C. with Persil and dried and ashed in the manner previously described.

residue after ashing (% by weight)

| Sample | before wash | after wash |
|---|---|---|
| Reference | 0.25 | 0.32 |
| 35 | 0.709 | 0.81 |
| 38 | 0.699 | 0.78 |

The data show that the silverized glass spheres are very largely still present on the fabric after washing. Electron micrographs likewise show the presence of silver spheres on the fabric.

Demonstration of Biocidal Effect

Biocidal activity was determined by the challenge suspension test in accordance with the test method of the Hohenstein Institutes, Schloβ Hohenstein, D-74357 Bönnigheim. (See presentation by Dr. Helmut Mucha at 5th Dresden Textile Symposium 2000).

The table reports the kill rates after 2 (and 6 hours) exposure.

| Fabric sample | | E-Coli | | Micrococus luteus |
|---|---|---|---|---|
| 10 | 60 | (99.9) | 60 | (99.9) |
| 23 | 60 | (99.9) | 50 | (99.9) |
| 34 | 50 | (80) | 60 | (80) |
| 35 | 80 | (99.9) | 90 | (99.9) |

1. A process for antimicrobial finishing of a textile fabric, comprising the steps of:
a) treating said textile fabric with a first dilute aqueous liquor comprising at least one water-soluble polymeric dispersant and/or a polymeric thickener and at least one particulate silvery constituent selected from
i) sparingly water-soluble salts of silver,
ii) a silver sol and
iii) a pulverulent silvery material, and
a) treating said textile fabric with a second aqueous liquor b) comprising an aqueous composition of a binder.

2. The process according to claim 1 wherein said water-soluble polymeric dispersant is gelatin.

3. The process according to claim 1 wherein the first liquor contains an aqueous dispersion of a sparingly water-soluble salt of silver as the silvery constituent, said aqueous dispersion being obtained by addition of a precipitant to an aqueous solution of a soluble salt of silver comprising said water-soluble polymeric dispersant.

4. The process according to claim 1 wherein said sparingly soluble salt of silver is a silver halide or a mixture of silver halides.

5. The process according to claim 3 further comprising reducing said salt of silver.

6. The process according to claim 1 wherein the first liquor contains a silver sol as the silvery constituent, said silver sol was obtained by adding a reducing agent to an aqueous solution of a soluble salt of silver comprising said water-soluble polymeric dispersant.

7. The process according to claim 2 wherein the first liquor contains a dispersed silver-coated glass powder having an average particle size in the range from 0.5 to 50 μm as the silvery constituent.

8. The process according to claim 7 wherein said first liquor further comprises a sparingly water-soluble silvery constituent having an average particle size below 500 nm.

9. The process according to claim 1 wherein the concentration of silvery constituents in said first liquor is in the range from 0.01 to 1 g/l, calculated as silver.

10. The process according to claim 1 wherein said binder used in step b) comprises isocyanate groups or reversibly blocked isocyanate groups.

11. The process according to claim 10 wherein said binder is a reactive polyurethane.

12. The process according to claim 1 wherein said binder used in step b) comprises at least one crosslinkable compound having at least two N-hydroxymethyl groups.

13. The process according to claim 1 wherein said binder is a polymeric binder having a glass transition temperature in the range from −20 to +60° C.

14. The process according to claim 1 wherein the concentration of binder in the second liquor is in the range from 10 to 300 g/l.

15. A textile fabric obtainable by a process according to claim 1.
